(19) United States
(12) Patent Application Publication
(10) Pub. No.: US 2024/0017500 A1
(43) Pub. Date: Jan. 18, 2024

(54) SYSTEM AND METHOD FOR WELDING THERMOPLASTIC MATERIALS TO GLASS

(71) Applicant: Edison Welding Institute, Inc., Columbus, OH (US)

(72) Inventors: Jeffrey Ellis, Columbus, OH (US); Miranda Marcus, Columbus, OH (US); Matthew Nitsch, Columbus, OH (US); Jessica Whitman, Columbus, OH (US)

(21) Appl. No.: 17/864,651

(22) Filed: Jul. 14, 2022

(51) Int. Cl. B29C 65/16; B29C 65/44; B29K 309/08

(52) U.S. Cl. CPC B29C 65/1616; B29C 65/44; B29K 2309/08

(57) ABSTRACT

A method for joining thermoplastics to glass comprising placing a sheet of continuous glass filled thermoplastic composite under glass; applying a predetermined amount of force on the bottom of the composite to achieve adequate contact and compaction between the composite and the glass; using a laser with a predetermined wavelength having a predetermined spot size to apply a predetermined amount of power to a predefined region of the composite and the glass at a predetermined speed, thereby creating a weld between the composite and the glass; cooling the joined materials for a predetermined period of time while still under compaction pressure; and removing the compaction pressure to access the joined materials.

### BACKGROUND

The disclosed technology relates in general to a systems, device, and methods for joining dissimilar materials to one another, and more specifically to a system and method for joining thermoplastic materials to glass for use in various industrial and commercial applications.

Joining dissimilar materials (also referred to as “dissimilar materials joining”) refers to the process of combining different materials (or creating materials combinations), wherein the materials are typically more difficult to join due to their dissimilarity than multiple pieces of the same material (or alloys having minor differences in composition) would be to join. Regardless of difficulties encountered when creating certain materials combinations, many dissimilar materials can be successfully joined using appropriate joining process and various specialized procedures. Dissimilar material joining has been successfully used with metallic systems having industrial applications such as stainless steel, nickel, copper, and aluminum alloys. Dissimilar material joining has also been used with titanium alloys, ceramics, polymers, and composite materials. Special performance requirements for corrosion resistance, high strength-to-weight ratio, erosion resistance, or high-temperature strength, for example, in certain engineering applications has generally increased the use of dissimilar material joining in industry.

Designing unique structures or parts having specifically engineered properties can involve the joining of dissimilar materials, each having different physical, chemical, or mechanical properties. For example, a structure or part may require high-temperature resistance in one area or region of the part and high corrosion resistance in another area or region of the part. In another example, a structure may require a certain toughness or wear resistance in one area or region, combined with high strength in another area or region. Joining dissimilar materials having certain engineered properties enables the creation of light-weight automotive structures, improves methods for energy production, drives the creation of next generation medical products and consumer products and devices, and enables or enhances many other manufacturing and industrial processes. However, no single process or set of processing parameters is considered superior or applies to all situations involving material combinations. Each existing process has certain advantages and certain limitations. Creation of a dissimilar material joint should be viewed as a special application having unique requirements; therefore, the ongoing development of new systems, devices, and methods for joining dissimilar materials is advantageous.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a first method for joining thermoplastics to glass. This method comprises placing a sheet of continuous glass filled thermoplastic composite under glass; applying a predetermined amount of force on the bottom of the composite to achieve adequate contact and compaction between the composite and the glass; and using a laser with a predetermined wavelength having a predetermined spot size to apply a predetermined amount of power to a predefined region of the composite and the glass at a predetermined speed, thereby creating a weld between the composite and the glass and joining the materials. The method may further comprise cooling the welded materials for a predetermined period of time while still under compaction pressure, and then removing the compaction pressure to access the joined materials. The predetermined amount of force may be in the range of 10-10,000 psi or may be 100 psi. The predetermined wavelength may be in the range of 800-5500 nm or may be 975 nm. The predetermined spot size may be in the range of 0.1-100 mm or may be 2 mm. The predetermined amount of power may be in the range of 0.1-20,000 watts or may be 60 watts. The predetermined speed may be in the range of 0.1-10,000 mm/second or may be 2.8 mm/second. The predetermined cooling time may be in the range of 0.1-30 seconds or may be three seconds.

Another implementation of the disclosed technology provides a second method for joining thermoplastics to glass. This method comprises placing a sheet of continuous glass filled thermoplastic composite under glass; applying force in the range of 10-10,000 psi on the bottom of the composite to achieve adequate contact and compaction between the composite and the glass; and using a laser with a wavelength in the range of 800-5500 nm having a spot size in the range of 0.1-100 mm to apply power in the range of 0.1-20,000 watts to a predefined region of the composite and the glass at a speed in the range of 0.1-10,000 mm/second, thereby creating a weld between the composite and the glass. The method may further comprise cooling the joined materials for a predetermined period of time while still under compaction pressure and removing the compaction pressure to access the joined materials. The predetermined cooling time may be in the range of 0.1-30 seconds.

Another implementation of the disclosed technology provides a third method for joining thermoplastics to glass. This method comprises placing a sheet of continuous glass filled thermoplastic composite under glass; applying 100 psi of force on the bottom of the composite to achieve adequate contact and compaction between the composite and the glass; using a laser with a wavelength of 975 mm having a spot size of 2 mm to apply 60 watts of power to a predefined region of the composite and the glass at a speed of 2.8 mm/second, thereby creating a weld between the composite and the glass; cooling the joined materials for three seconds while still under compaction pressure; and removing the compaction pressure to access the joined materials.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying FIGURES, which are incorporated into and form a part of the specification, schematically illustrate one or more example implementations of the disclosed technology and, together with the general description given above and detailed description given below, serve to explain the principles of the disclosed subject matter, and wherein:

FIG. 1 depicts a thermoplastic material laser welded to glass using an example implementation of the disclosed system, apparatus, and process.

### DETAILED DESCRIPTION

Example implementations are now described with reference to the FIGURES. Reference numerals may be used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific FIGURE. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Processes for joining dissimilar materials may be grouped as follows: (i) fusion arc welding processes, including shielded metal arc welding (SMAW), gas tungsten arc welding (GTAW or TIG), gas metal arc welding (GMAW), and plasma arc welding (PAW); (ii) other fusion welding processes, including laser welding, resistance spot and projection welding, resistance seam cladding, flash butt welding, plasma arc, and electron beam welding; (iii) solid-state joining processes, including friction stir welding, ultrasonic welding, friction and inertia welding, diffusion bonding, explosive bonding, and roll cladding; (iv) brazing and soldering; and (v) adhesive bonding. Various factors to be considered when designing dissimilar materials joints include the following: (a) overall joint design and material thicknesses; (b) differences in melting temperatures between materials; (c) thermal expansion/contraction mismatches during joining and in-service; (d) fixturing and constraint effects on joining stresses; (e) formation of brittle intermetallic compounds during joining which may result in brittle joints; (f) heating and cooling rate effects on the microstructure of the joint, which may affect the strength and require precision control of heat input; (g) pre and post heating requirements for minimizing stresses during welding and cooling; (h) requirements for composite transition materials or special filler materials during joining; and (i) potential for galvanic corrosion problems in-service.

The disclosed technology provides systems, devices, and methods for joining thermoplastics to glass without the use of additional adherents or fasteners. Laser welding of plastics and metals is known but welding the dissimilar materials of thermoplastic and glass is a novel use of laser welding. Applications of the disclosed technology include use in products that include mixed materials such as smart phones, smart windows, and solar panels. This technology effectively increases productivity, decreases cycle time, and decreases manufacturing costs of these products due to its high speed, shape adaptability, and low expense. Target markets for the disclosed technology include consumer goods and energy.

A thermoplastic, or thermosoft plastic, is characterized as a plastic polymer material that becomes pliable or moldable at a certain elevated temperature and then solidifies upon cooling. Most thermoplastics have a high molecular weight. The polymer chains associate by intermolecular forces, which weaken rapidly with increased temperature, yielding a viscous liquid. In this state, thermoplastics may be reshaped and are typically used to produce parts by various polymer processing techniques such as injection molding, compression molding, calendering, and extrusion. Above its glass transition temperature and below its melting point, the physical properties of a thermoplastic change drastically without an associated phase change. Some thermoplastics do not crystallize below the glass transition temperature, retaining some or all of their amorphous characteristics. Amorphous plastics are used when high optical clarity is necessary, as light is scattered strongly by crystallites larger than its wavelength. Amorphous plastics are less resistant to chemical attack and environmental stress cracking because they lack a crystalline structure.

Polyetherimide (PEI), which is a thermoplastic, is produced by a novel nitro displacement reaction involving bisphenol A, 4, 4′-methylenedianiline and 3-nitrophthalic anhydride and exhibits high heat distortion temperature, tensile strength, and modulus. PEI is generally used in high-performance electrical and electronic parts, microwave appliances, and under-the-hood automotive parts. Polyphenylene sulfide (PPS), which is also a thermoplastic, is produced by the condensation polymerization of p-dichlorobenzene and sodium sulfide, and exhibits outstanding chemical resistance, good electrical properties, excellent flame retardance, low coefficient of friction, and high transparency to microwave radiation. PPS is principally used in coating applications by spraying an aqueous slurry of PPS particles and heating to temperatures above 370° C. Particular grades of PPS can be used in injection and compression molding at temperatures (300° C. to 370° C.) at which PPS particles soften and undergo apparent crosslinking. Principal applications of injection and compression molded PPS include cookware, bearings, and pump parts for service in various corrosive environments.

Glass is typically defined as any of a large class of materials with highly variable mechanical and optical properties that solidify from the molten state without crystallization; are typically made by silicates fusing with boric oxide, aluminum oxide, or phosphorus pentoxide; are generally hard, brittle, and transparent or translucent; and are considered to be supercooled liquids rather than true solids. BOROFLOAT® glass is a specialty glass material having a low coefficient of thermal expansion, extremely high transparency in the near-infrared and ultraviolet ranges, and high resistance to acids and alkalis.

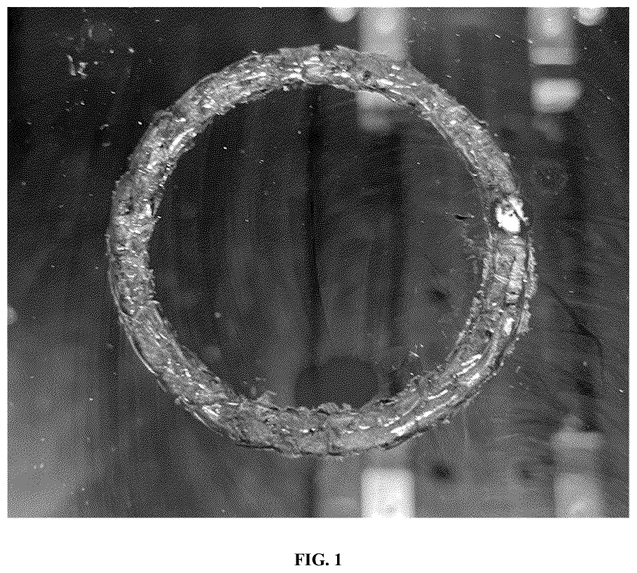

With reference to FIG. 1, the disclosed system and method was used to join glass fiber reinforced polyetherimide to Schott BOROFLOAT® glass and glass fiber reinforced polyphenylene sulfide to BOROFLOAT® glass. An example implementation of the disclosed joining process utilizes a Leister Novolas WS-AT 975 nm wavelength laser at or below 200 watts, with 100 psi compaction force, and a beam spot size of approximately 2 mm. The specimen pictured in FIG. 1 was welded at 60 watts for a duration of 40 seconds in a circular pattern approximately 2 inches in diameter. Through transmission laser welding of the materials with the borosilicate glass positioned closer to the beam, it was possible to achieve a bond to the point where the thermoplastic (and some broken glass fiber) could not be removed.

In one example implementation of the disclosed technology, thermoplastic is laser welded to glass using the following process: (i) place a sheet of continuous glass filled thermoplastic composite (e.g., TECATEC PPS GF50 or TECATEC PEI GF50 from Ensinger Composites Schweiz GmbH) under glass (e.g., laser glass); (ii) apply a predetermined amount of force (e.g., 100 psi) on the bottom of the composite to achieve adequate contact and compaction between the composite and the glass; (iii) use a laser with a predetermined wavelength (e.g., 975 mm) having a predetermined spot size (e.g., 2 mm) to apply a predetermined amount of power (e.g., 60 watts) in a circle having a predetermined radius (e.g., 17 mm) at a predetermined speed (e.g., 2.8 mm/second); (iv) allow cooling for a predetermined period of time (e.g., three seconds) while still under compaction pressure; and (v) remove the compaction pressure to access the joined materials. In other implementations, the force may be in the range of 10-10,000 psi; the wavelength may be in the range of 800-5500 nm; the spot size may be in the range of 0.1-100 mm; the amount of power may be in the range of 0.1-20,000 watts; the speed may be in the range of 0.1-10,000 mm/second; and the cooling time may be in the range of 0.1-30 seconds.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

Regarding this disclosure, the term “a plurality of” refers to two or more than two. Unless otherwise clearly defined, orientation or positional relations indicated by terms such as “upper” and “lower” are based on the orientation or positional relations as shown in the FIGURES, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection; a direct connection, or an indirect connection through an intermediate medium. For an ordinary skilled in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A method for joining thermoplastics to glass comprising:
(a) placing a sheet of continuous glass filled thermoplastic composite under glass;
(b) applying a predetermined amount of force on the bottom of the composite to achieve adequate contact and compaction between the composite and the glass; and
(c) using a laser with a predetermined wavelength having a predetermined spot size to apply a predetermined amount of power to a predefined region of the composite and the glass at a predetermined speed, thereby creating a weld between the composite and the glass.

2. The method of claim 1, further comprising cooling the joined materials for a predetermined period of time while still under compaction pressure.

3. The method of claim 2, further comprising removing the compaction pressure to access the joined materials.

4. The method of claim 1, wherein the predetermined amount of force in the range of 10 to psi.

5. The method of claim 1, wherein the predetermined amount of force is 100 psi.

6. The method of claim 1, wherein predetermined wavelength is in the range of 800 to 5500 nm.

7. The method of claim 1, wherein predetermined wavelength is 975 nm.

8. The method of claim 1, wherein the predetermined spot size is in the range of 0.1 to 100 mm.

9. The method of claim 1, wherein the predetermined spot size is 2 mm.

10. The method of claim 1, wherein the predetermined amount of power is in the range of 0.1 to 20,000 watts.

11. The method of claim 1, wherein the predetermined amount of power is 60 watts.

12. The method of claim 1, wherein the predetermined speed is in the range of 0.1 to 10,000 mm/second.

13. The method of claim 1, wherein the predetermined speed is 2.8 mm/second.

14. The method of claim 2, wherein the predetermined cooling time is in the range of 0.1 to 30 seconds.

15. The method of claim 2, wherein the predetermined cooling time is three seconds.

16. A method for joining thermoplastics to glass comprising:
(a) placing a sheet of continuous glass filled thermoplastic composite under glass;
(b) applying force in the range of 10 to 10,000 psi on the bottom of the composite to achieve adequate contact and compaction between the composite and the glass; and
(c) using a laser with a wavelength in the range of 800 to 5500 nm having a spot size in the range of 0.1 to 100 mm to apply power in the range of 0.1 to 20,000 watts to a predefined region of the composite and the glass at a speed in the range of 0.1 to 10,000 mm/second, thereby creating a weld between the composite and the glass.

17. The method of claim 16, further comprising cooling the joined materials for a predetermined period of time while still under compaction pressure.

18. The method of claim 17, further comprising removing the compaction pressure to access the joined materials.

19. The method of claim 17, wherein the predetermined cooling time is in the range of 0.1 to seconds.

20. A method for joining thermoplastics to glass comprising:
(a) placing a sheet of continuous glass filled thermoplastic composite under glass;
(b) applying 100 psi of force on the bottom of the composite to achieve adequate contact and compaction between the composite and the glass;
(c) using a laser with a wavelength of 975 mm having a spot size of 2 mm to apply 60 watts of power to a predefined region of the composite and the glass at a speed of 2.8 mm/second, thereby creating a weld between the composite and the glass;
(d) cooling the joined materials for three seconds while still under compaction pressure; and
(e) removing the compaction pressure to access the joined materials.
